(19) United States
(12) Patent Application Publication
(10) Pub. No.: US 2017/0364992 A1
(43) Pub. Date: Dec. 21, 2017

(54) RECOMMENDATION DEVICE, RECOMMENDATION SYSTEM, RECOMMENDATION METHOD, AND PROGRAM

(71) Applicant: FUJIFILM Corporation, Tokyo (JP)

(72) Inventor: Yukinori NOGUCHI, Kanagawa (JP)

(73) Assignee: FUJIFILM Corporation, Tokyo (JP)

(21) Appl. No.: 15/695,013

(22) Filed: Sep. 5, 2017

Related U.S. Application Data
(63) Continuation of application No. PCT/JP2016/053511, filed on Feb. 5, 2016.

(30) Foreign Application Priority Data
Mar. 25, 2015 (JP) 2015-063138

(51) Int. Cl. G06Q 30/06; G06F 7/02

(52) U.S. Cl. CPC G06Q 30/0631; G06F 7/026; G06Q 30/0643

(57) ABSTRACT

A recommendation device 10 includes an evaluation reference group information acquisition unit 41 that acquires evaluation reference group information related to a plurality of first products constituting an evaluation reference group, an evaluation rule acquisition unit 43 that acquires an evaluation rule, a first evaluation unit 45 that performs individual evaluation of one-to-one of each of the plurality of first products and a plurality of second products on the basis of the evaluation rule, a second evaluation unit 47 that performs many-to-one overall evaluation on each of the plurality of second products for the evaluation reference group on the basis of the individual evaluation performed by the first evaluation unit, and a recommendation information output unit 49 that outputs recommendation information of the plurality of second products on the basis of the overall evaluation performed by the second evaluation unit.

### CROSS-REFERENCE TO RELATED APPLICATIONS

This application is a Continuation of PCT International Application No. PCT/JP2016/ 053511 filed on Feb. 5, 2016, which claims priority under 35 U.S.0 §119(a) to Patent Application No. 2015- 063138 filed in Japan on Mar. 25, 2015, all of which are hereby expressly incorporated by reference into the present application.

### BACKGROUND OF THE INVENTION

### 1. Field of the Invention

The present invention relates to a recommendation device, a recommendation system, a recommendation method, and non-transitory computer recording medium storing a program, and particularly, to a recommendation device, a recommendation system, a recommendation method, and a program for recommending a second product by evaluating a combination of a first product and the second product.

### 2. Description of the Related Art

In a case where a consumer (user) purchases clothing-related products at an electronic commerce (EC) site on the Internet, the consumer may purchase the products by considering (coordinating) a combination so that two or more kinds of products are in harmony.

However, some users may not have confidence in their own sense of fashion and may desire to get others' advice on coordination.

Conventionally, a technology for providing an advice for coordination to a user and supporting purchase in a case where the user purchases clothes or the like on an EC site has been proposed in order to cope with the above demand.

For example, JP2012-14544A discloses a technology for setting a photograph of clothing described in a fashion magazine or the like as a photographic image for reference and supporting coordination with an item selected by a user on the basis of the photographic image for reference.

Further, for example, JP2006-119836A describes a technology in which one item of clothing is selected from a plurality of items of clothing owned by a user and color matching (coordination) with the selected item is performed.

### SUMMARY OF THE INVENTION

Here, for example, in a case where a user considers purchase of pants at an EC site, the user may already own a plurality of shirts and consider purchase of the pants matching the plurality of owned shirts. That is, the user may desire to purchase pants that can be worn with the plurality of shirts that the user has already possessed.

Even in a case where there is no much money, it is conceivable that purchase can be further promoted by proposing clothing that can be worn as described above.

However, in the technologies described in JP2012-14544A and JP2006-119836A, an item coordinated for one selected item (clothing) is merely proposed. That is, in the technologies described in JP2012-14544A and JP2006-119836A, there is one item serving as a reference for evaluation in a case where coordination is performed, and one-to-many coordination is performed. In such a one-to-many coordination technology, in a case where there are a plurality of items serving as evaluation references, it is difficult to propose a product desired by a user. That is, it may be difficult to propose pants that can be worn with a plurality of shirts owned by the user.

The present invention has been made in view of such circumstances, and an object thereof is to provide a recommendation device, a recommendation system, a recommendation method, and a non-transitory computer recording medium storing a program capable of recommending a product in consideration of a combination with each of a plurality of products.

A recommendation device that is an aspect of the present invention for achieving the above object is a recommendation device that evaluates each of a plurality of first products constituting an evaluation reference group and a plurality of second products belonging to a category different from that of the first products on the basis of an evaluation rule, and performs recommendation of one or a plurality of second products, the recommendation device comprising: an evaluation reference group information acquisition unit that acquires evaluation reference group information related to the plurality of first products constituting the evaluation reference group; an evaluation rule acquisition unit that acquires the evaluation rule; a first evaluation unit that performs individual evaluation of one-to-one of each of the plurality of first products and the plurality of second products on the basis of the evaluation rule; a second evaluation unit that performs many-to-one overall evaluation on each of the plurality of second products for the evaluation reference group on the basis of the individual evaluation performed by the first evaluation unit; and a recommendation information output unit that outputs recommendation information of the plurality of second products on the basis of the overall evaluation performed by the second evaluation unit.

According to this aspect, the one-to-one individual evaluation is performed by the first evaluation unit, and the many-to-one overall evaluation is performed by the second evaluation unit on the basis of the individual evaluation performed by the first evaluation unit. Thus, in this aspect, it is possible to recommend one or a plurality of second products in consideration of a combination with each of a plurality of first products.

Preferably, the first evaluation unit calculates an individual evaluation value for each individual evaluation, and the second evaluation unit performs the overall evaluation on each of the plurality of second products using the individual evaluation value.

According to this aspect, since the first evaluation unit calculates the individual evaluation value for each one-to-one individual evaluation and the second evaluation unit performs the overall evaluation using the individual evaluation value, the individual evaluation and the overall evaluation are performed more accurately.

Preferably, the overall evaluation is performed by calculating a total evaluation value obtained by summing the individual evaluation values.

According to this aspect, since the second evaluation unit performs the overall evaluation by calculating the total evaluation value obtained by summing the individual evaluation values, more accurate overall evaluation is performed.

Preferably, the recommendation information output unit has a threshold value for determining the individual evaluation value, and causes mismatch information which is information on the second product having the individual evaluation value equal to or smaller than the threshold value to be included in the recommendation information.

According to this aspect, mismatch information is included in the recommendation information of the second products having the individual evaluation value equal to or smaller than the threshold value. Accordingly, in this aspect, it is possible to specify the second product having the individual evaluation value equal to or smaller than the threshold value.

Preferably, the mismatch information includes information on the first product of which the individual evaluation value is equal to or smaller than the threshold value, and the second product.

According to this aspect, since the mismatch information includes information on the first product of which the individual evaluation value is equal to or smaller than the threshold value, and the second product, it is possible to specify a combination of the first product of which the individual evaluation value is equal to or smaller than the threshold value, and the second product.

Preferably, the recommendation information includes information on a product image of the first product, information on a product image of the second product, and display information on the mismatch information.

According to this aspect, since the recommendation information includes the information on the product image of the first product, the information on the product image of the second product, and the display information on the mismatch information, a display regarding the first product image, the second product image, and the mismatch information to be displayed on the display unit is displayed, and the user can visually confirm evaluation of the combination of the first product and the second product.

Preferably, the first evaluation unit sets products stored in a product database as the second products and performs the individual evaluation.

According to this aspect, since the first evaluation unit sets the products stored in the product database as the second products and performs the individual evaluation, it is possible to perform the individual evaluation using the information on the products stored in the product database with high accuracy.

Preferably, the evaluation reference group information acquisition unit acquires purchase history information of a user and favorite information of the user as the evaluation reference group information.

According to this aspect, since the purchase history information of the user or the favorite information of the user is acquired as the evaluation reference group information, a product purchased by a user or a product registered in the favorites can be used as a product in an evaluation reference group. Thus, in this aspect, it is possible to perform recommendation of products in consideration of a combination with a product purchased by a user or a product registered in the favorites.

Preferably, the first product and the second product are clothing-related products.

According to this aspect, since the first product and the second product are clothing-related products, the individual evaluation and the overall evaluation are performed on the clothing-related products. Thus, in this aspect, it is possible to perform recommendation of the second products that can be worn with a plurality of first products.

A recommendation system according to another aspect of the present invention is a recommendation system comprising a user terminal, and a recommendation device connected to the user terminal over a network, the recommendation device evaluating each of a plurality of first products constituting an evaluation reference group and a plurality of second products belonging to a category different from that of the first products on the basis of an evaluation rule, and performing recommendation of one or a plurality of second products, wherein the recommendation device includes an evaluation reference group information acquisition unit that acquires evaluation reference group information related to the plurality of first products constituting the evaluation reference group, an evaluation rule acquisition unit that acquires the evaluation rule, a first evaluation unit that performs individual evaluation of one-to-one of each of the plurality of first products and the plurality of second products on the basis of the evaluation rule, a second evaluation unit that performs many-to-one overall evaluation on each of the plurality of second products for the evaluation reference group on the basis of the individual evaluation performed by the first evaluation unit, and a recommendation information output unit that outputs recommendation information of the plurality of second products on the basis of the overall evaluation performed by the second evaluation unit, and the user terminal includes a display unit, and a display control unit that causes the display unit to perform a display based on the recommendation information, on the basis of the recommendation information acquired from the recommendation device.

According to this aspect, in the recommendation device, the one-to-one individual evaluation is performed by the first evaluation unit, and the many-to-one overall evaluation is performed by the second evaluation unit on the basis of the individual evaluation performed by the first evaluation unit. Thus, in this aspect, it is possible to recommend one or a plurality of second products in consideration of a combination with each of a plurality of first products.

Further, according to this aspect, in the user terminal, since the display is performed on the basis of the recommendation information on the display unit, the user can visually recognize the recommendation information.

Preferably, the evaluation reference group information acquisition unit of the recommendation device acquires the evaluation reference group information from the user terminal, and the user terminal includes an evaluation reference group information output unit that outputs the evaluation reference group information to the recommendation device.

According to this aspect, the evaluation reference group information is output from the user terminal, and the output evaluation reference group information is acquired by the recommendation device. Thus, in this aspect, the information that the user terminal has can be utilized as the evaluation reference group information.

Preferably, the evaluation rule acquisition unit of the recommendation device acquires the evaluation rule from the user terminal, and the user terminal includes an evaluation rule output unit that outputs the evaluation rule to the recommendation device.

According to this aspect, the evaluation rule is output from the user terminal, and the output evaluation rule is acquired by the recommendation device. Thus, in this aspect, it is possible to recommend the products on the basis of the evaluation rule output by the user terminal.

A recommendation method according to still another aspect of the present invention is a recommendation method of evaluating each of a plurality of first products constituting an evaluation reference group and a plurality of second products belonging to a category different from that of the first products on the basis of an evaluation rule, and performing recommendation of one or a plurality of second products, the recommendation method comprising: an evaluation reference group information acquisition step of acquiring evaluation reference group information related to the plurality of first products constituting the evaluation reference group; an evaluation rule acquisition step of acquiring the evaluation rule; a first evaluation step of performing individual evaluation of one-to-one of each of the plurality of first products and the plurality of second products on the basis of the evaluation rule; a second evaluation step of performing many-to-one overall evaluation on each of the plurality of second products for the evaluation reference group on the basis of the individual evaluation performed in the first evaluation step; and a recommendation information output step of outputting recommendation information of the plurality of second products on the basis of the overall evaluation performed in the second evaluation step.

A non-transitory computer recording medium storing a program that is still another aspect of the present invention is a program that causes a computer to execute a process of evaluating each of a plurality of first products constituting an evaluation reference group and a plurality of second products belonging to a category different from that of the first products on the basis of an evaluation rule, and performing recommendation of one or a plurality of second products, the program causing the computer to execute: an evaluation reference group information acquisition step of acquiring evaluation reference group information related to the plurality of first products constituting the evaluation reference group; an evaluation rule acquisition step of acquiring the evaluation rule; a first evaluation step of performing individual evaluation of one-to-one of each of the plurality of first products and the plurality of second products on the basis of the evaluation rule; a second evaluation step of performing many-to-one overall evaluation on each of the plurality of second products for the evaluation reference group on the basis of the individual evaluation performed in the first evaluation step; and a recommendation information output step of outputting recommendation information of the plurality of second products on the basis of the overall evaluation performed in the second evaluation step.

According to the present invention, since the one-to-one individual evaluation is performed by the first evaluation unit and the many-to-one overall evaluation is performed by the second evaluation unit on the basis of the individual evaluation performed by the first evaluation unit, it is possible to recommend one or a plurality of second products in consideration of a combination with each of the plurality of first products.

### BRIEF DESCRIPTION OF THE DRAWINGS

FIG. 1 is a diagram illustrating one-to-many recommendation.

FIG. 2 is a diagram illustrating recommendation of the present invention.

FIG. 3 is a conceptual diagram of a recommendation system.

FIG. 4 is a block diagram illustrating a functional configuration example of a user terminal.

FIG. 5 is a diagram illustrating an appearance of a user terminal.

FIG. 6 is a block diagram illustrating a functional configuration example of a recommendation device.

FIG. 7 is a conceptual diagram of a data structure of data regarding products stored in a product database.

FIG. 8 is a conceptual diagram illustrating a relationship between a sensitivity space and a physical measurement space.

FIG. 9 is a conceptual diagram of an evaluation rule table stored in an evaluation rule table database.

FIG. 10 is a conceptual diagram illustrating individual evaluation performed by a first evaluation unit.

FIG. 11 is a conceptual diagram illustrating individual evaluation performed by the first evaluation unit.

FIG. 12 is a conceptual diagram illustrating individual evaluation performed by the first evaluation unit.

FIG. 13 is a conceptual diagram illustrating individual evaluation performed by the first evaluation unit.

FIG. 14 is a conceptual diagram illustrating individual evaluation performed by the first evaluation unit.

FIG. 15 is a conceptual diagram illustrating overall evaluation performed by a second evaluation unit.

FIG. 16 is a diagram illustrating a display form of recommendation information displayed on a display unit of a user terminal.

FIG. 17 is a diagram illustrating an operation flow of a recommendation system.

### DESCRIPTION OF THE PREFERRED EMBODIMENTS

Hereinafter, embodiments of a recommendation device, a recommendation system, a recommendation method, and non-transitory computer recording medium storing a program according to the present invention will be described with reference to the accompanying drawings. In the following embodiment, an example in which “clothing accessory and, particularly, clothing” is a coordination target product will be described. However, the present invention is not limited thereto and is also applicable to a case where combination of another arbitrary product is performed. For example, the present invention is applicable to, for example, a combination of a main illustration and a background illustration, a combination of a postcard illustration and a character illustration, or the like to perform recommendation.

In the following description, the first product refers to a product that is a reference in a case where a combination is evaluated, and the second product refers to a product of which a combination with the first product is evaluated, and that is recommended on the basis of the evaluation. Further, in the following description, the first product and the second product are products that are clothing and of which categories are different. For example, in a case where the first product is a top, the second product is a bottom, and in a case where the first product is the bottom, the second product is the top. A combination of the first product and the second product is not limited thereto and various combinations can be adopted.

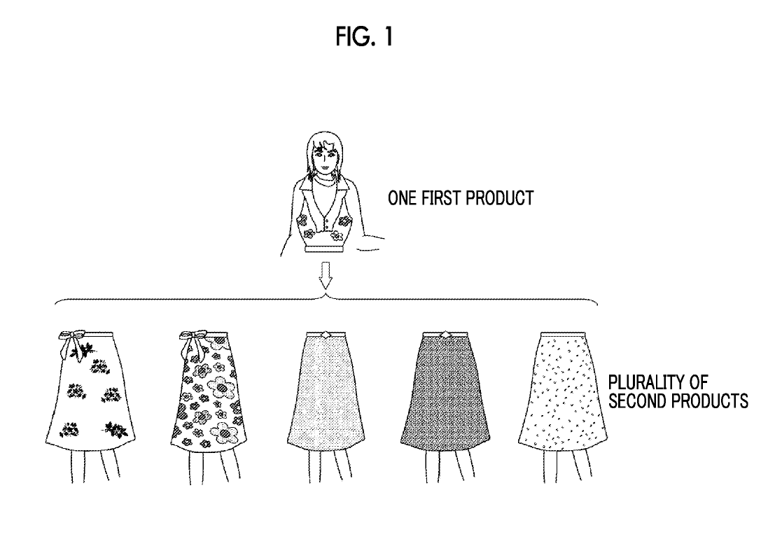

FIG. 1 is a diagram illustrating one-to-many recommendation. In FIG. 1, five second products (bottoms) are recommended for one first product (tops) selected by a user on the basis of an arbitrary evaluation rule. That is, “one-to-many” recommendation in which a plurality of second products are recommended on the basis of one first product is performed. The “one-to-many” recommendation is effective in a case where a second product is recommended in consideration of a combination with one first product. However, it is difficult to recommend the second products in consideration of a combination with a plurality of first products.

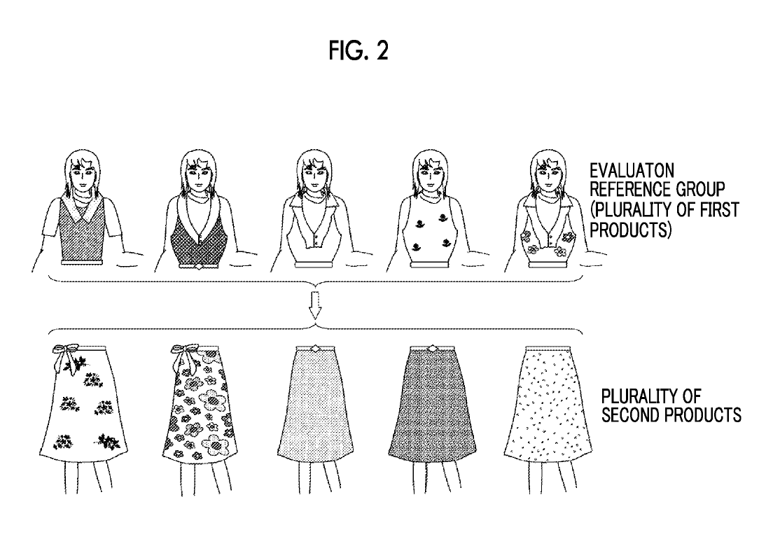

FIG. 2 is a diagram illustrating recommendation of the present invention. In FIG. 2, for example, five second products (bottoms) are recommended on the basis of an arbitrary evaluation rule for an evaluation reference group consisting of a plurality of first products (tops) owned by a user. That is, a plurality of second products are recommended in consideration of a combination with each of the plurality of first products constituting the evaluation reference group. Although the second products to be recommended are exemplified as (bottoms), clothing-related products in an arbitrary category as well as (bottoms) may be recommended, and second products may be recommended from clothing-related products in a plurality of categories.

Thus, in the recommendation performed in the present invention, the second products can be recommended by performing evaluation on the basis of the plurality of first products.

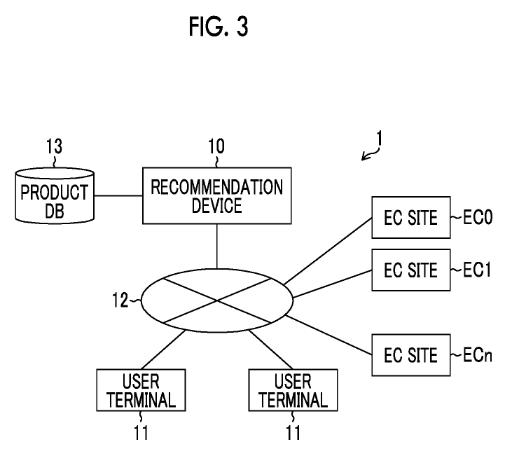

FIG. 3 is a conceptual diagram of a recommendation system (client server system) 1 including the recommendation device 10 according to the present invention. The recommendation system 1 according to this embodiment is configured by connecting the recommendation device 10, a plurality of user terminals 11 of general consumers (users), and a plurality of electronic commerce sites (EC sites) EC0 to ECn over a network 12 such as the Internet. Further, a product database 13 in which products and information on the products are associated and registered is connected to the recommendation device 10.

The recommendation device 10 evaluates each of the plurality of first products constituting the evaluation reference group and the plurality of second products belonging to a category different from the first product on the basis of an evaluation rule, and performs recommendation of one or a plurality of second products.

The recommendation device 10 corresponds to a server in the recommendation system 1, and the user terminal 11 and the EC sites EC0 to ECn correspond to clients in the recommendation system 1. The recommendation device 10 recommends coordinated products that are products acquired by appropriately combining (coordinating) two or more products to the user.

The product database (DB) 13 is connected to the recommendation device 10. The recommendation device 10 can appropriately access the product database 13 and can appropriately refer to and acquire the information on the product and product images registered in the product database 13. The product database 13 includes storage means such as a hard disc drive (HDD) or a solid state drive (SSD).

The user terminal 11 is a terminal that the user operates in a case where the user searches for products such as clothing. For example, the user terminal 11 is a portable terminal such as a smartphone or a tablet device, a personal computer, or the like.

The EC sites EC0 to ECn has a function of providing the recommendation device 10 with information on a product (for example, a product image, a brand, an inventory, a price, a size, a recommended product, or purchase information), or providing a user accessing the EC sites from the user terminal 11 via the recommendation device 10 or a user accessing the EC sites without via the recommendation device 10 with information on products handled in the EC site.

Next, a functional configuration of the user terminal 11 in the recommendation system 1 will be described.

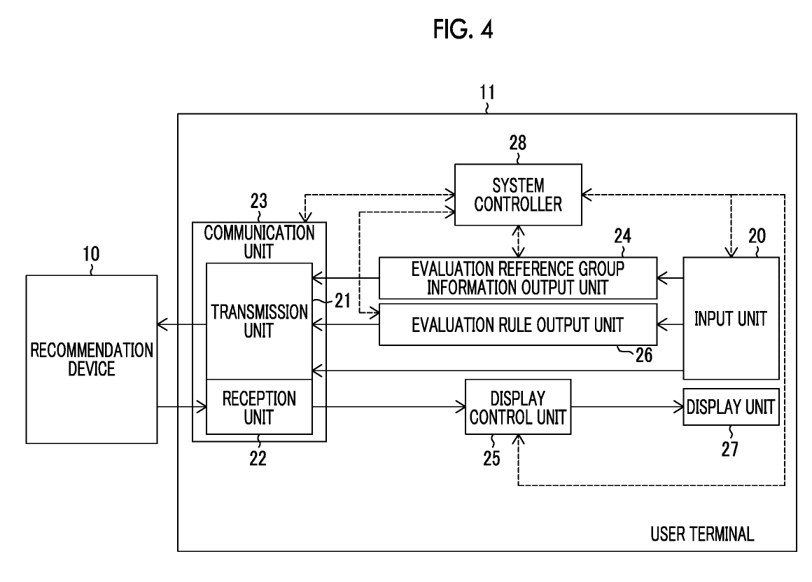

FIG. 4 is a block diagram illustrating a functional configuration example of the user terminal 11.

The user terminal 11 of this example mainly includes an input unit 20, a communication unit 23 (a transmission unit 21 and a reception unit 22), an evaluation reference group information output unit 24, an evaluation rule output unit 26, a display control unit 25, a display unit 27, and a system controller 28.

The input unit 20 includes an operation unit that is directly operated by a user in order to input data such as user identification information (user ID) (Identification), a password, or a search word, a selection of icons or the like that is displayed on the display unit 27, and an operation (tap, swipe, pinch, stretch, or the like) of a screen of the display unit 27, and an information specifying unit that specifies data such as a user ID, a password, a search word, or the like input via the operation unit. For example, the user can input his/her purchase history information or clothing information (favorite information) registered in the favorites via the input unit 20. Further, for example, the user can input an evaluation rule via the input unit 20.

The evaluation reference group information output unit 24 outputs the evaluation reference group information to the recommendation device. Here, the evaluation reference group information is information regarding a plurality of first products constituting the evaluation reference group, and is various kinds of information for specifying the first product. For example, the evaluation reference group information is a product ID (Identification), a product name, and a product image regarding the first product. Further, in a case where the evaluation reference group can be formed of the purchase history or the favorite information according to the user ID input from the input unit 20, the evaluation reference group information output unit 24 outputs the user ID as the evaluation reference group information.

The evaluation rule output unit 26 outputs the evaluation rule to the recommendation device. Here, the evaluation rule is a rule that is used in one-to-one individual evaluation that is performed by the first evaluation unit 45 of the recommendation device 10. For example, in a case where the evaluation rule is “cute”, the one-to-one individual evaluation of the first product and the second product is performed on the basis of “cute”. The individual evaluation will be described in detail below.

The display control unit 25 controls the display unit 27 to control an overall display of the display unit 27 and causes the display unit 27 to perform a display on the basis of acquired information. For example, the display control unit 25 acquires information on a product image of the first product included in the recommendation information acquired via the reception unit 22, information on a product image of the second product, and display information on mismatch information, and causes the display unit 27 to perform a display according to each pieces of acquired information.

The system controller 28 includes one or a plurality of central processing units (CPUs) or the like, and operates by loading various programs on the CPU. The system controller 28 controls the communication unit 23 (the transmission unit 21 and the reception unit 22), the input unit 20, the evaluation reference group information output unit 24, the evaluation rule output unit 26, and the display control unit 25 to cause each unit to execute the above-described process or other processes and control each unit (not illustrated) of the user terminal 11. For example, in a case where the user inputs the purchase history or the favorite information via the input unit 20, the system controller 28 performs control so that the purchase history or the favorite information is transmitted as the evaluation reference group information from the transmission unit 21 to the recommendation device 10 via the evaluation reference group information output unit 24. Further, for example, in a case where the user inputs the evaluation rule via the input unit 20, the system controller 28 performs control to transmit the evaluation rule from the transmission unit 21 to the recommendation device 10 via the evaluation rule output unit 26.

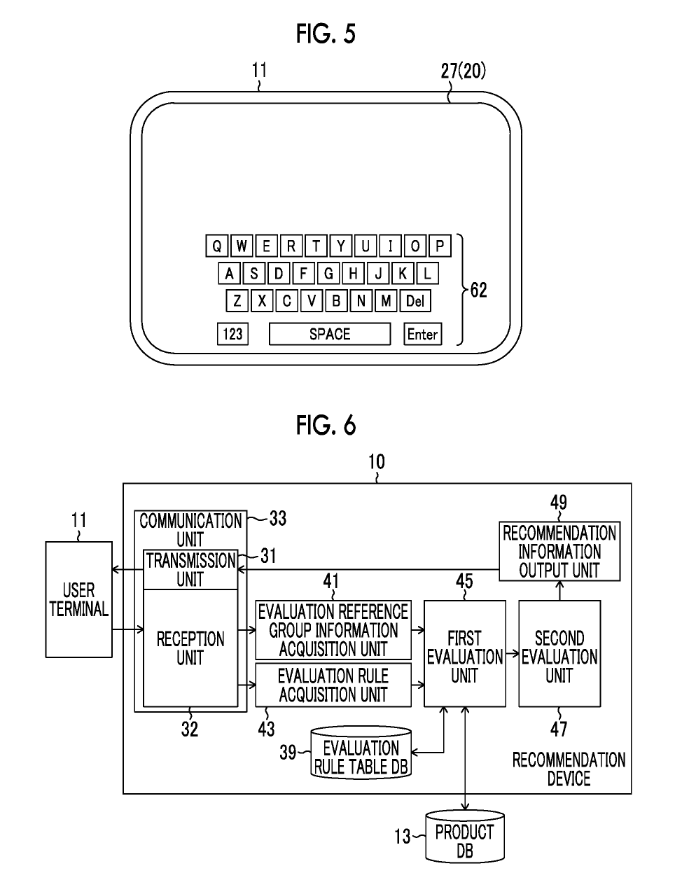

FIG. 5 is a diagram illustrating an appearance of the user terminal 11. In the case illustrated in FIG. 5, a portable terminal having a touch panel provided in the display unit 27 as a user operation unit (the input unit 20) is assumed to be the user terminal 11.

For example, a software keyboard 62 may be displayed as the input unit 20 on the display unit 27 of the user terminal 11. The software keyboard 62 includes an arbitrary character palette and a touch panel (the display unit 27) that are displayed on the display unit 27, and the user touches a portion corresponding to each character palette displayed on the display unit 27 in the touch panel, such that a character or the like corresponding to a touch position is input. The character palette displayed on the display unit 27 as the software keyboard 62 is not particularly limited, and function keys such as a space key, an enter key, a delete key, and a display switching key, as well as characters for input such as hiragana, alphabets, numbers, and symbols, can also be displayed as the software keyboard 62 on the display unit 27.

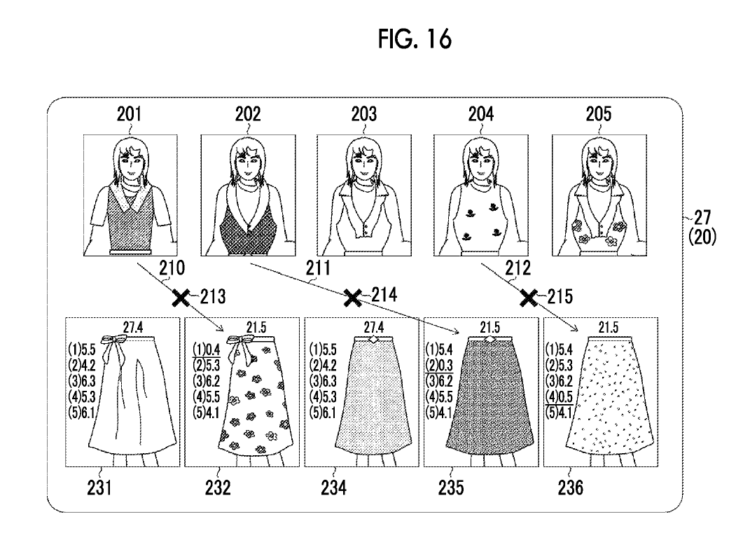

Further, a display regarding the product image of the first product, the product image of the second product, and the mismatch information is displayed on the display unit 27 (see FIG. 16). For example, the user can input selection of a product of a touched image by touching the product image of the first product or the product image of the second product.

Next, a functional configuration of the recommendation device 10 will be described.

FIG. 6 is a block diagram illustrating a functional configuration example of the recommendation device 10.

The recommendation device 10 has a function of recommending one or a plurality of second products to the user on the basis of the plurality of first products constituting the evaluation reference group.

The recommendation device 10 mainly includes a communication unit 33 (a transmission unit 31 and a reception unit 32), an evaluation reference group information acquisition unit 41, an evaluation rule acquisition unit 43, a first evaluation unit 45, a second evaluation unit 47, and a recommendation information output unit 49, as illustrated in FIG. 6. By loading various programs into one or a plurality of CPUs (not illustrated) included in the recommendation device 10, the CPU operates and each unit in the recommendation device 10 is controlled.

The reception unit 32 acquires information and data that are transmitted from the user terminal 11 over the network 12. For example, the reception unit 32 acquires evaluation reference group information and an evaluation rule. In a case where the reception unit 32 acquires the evaluation reference group information, the reception unit 32 transmits the evaluation reference group information to the evaluation reference group information acquisition unit 41. Further, in a case where the reception unit 32 acquires the evaluation rule, the reception unit 32 transmits the evaluation vile to the evaluation rule acquisition unit 43.

The evaluation reference group information acquisition unit 41 acquires the evaluation reference group information from the reception unit 32 and forms an evaluation reference group. For example, the evaluation reference group information acquisition unit 41 acquires a product ID regarding the first product and forms a product group of the product regarding the acquired product ID as the evaluation reference group. Further, the evaluation reference group may be stored in the evaluation reference group information acquisition unit 41 in advance, and in this case, the evaluation reference group information acquisition unit 41 does not have to acquire the evaluation reference group information from the user terminal 11 and transmits the previously stored evaluation reference group to the first evaluation unit 45. Further, the evaluation reference group information acquisition unit 41 may acquire purchase history information or favorite information of the user and form the evaluation reference group.

The evaluation rule acquisition unit 43 acquires the evaluation rule from the reception unit 32 and transmits the evaluation rule to the first evaluation unit 45. For example, the evaluation rule acquisition unit 43 acquires information indicating that evaluation is performed on the basis of “cute” as the evaluation rule from the reception unit 32 and transmits “cute” as the evaluation rule to the first evaluation unit 45. Further, the evaluation rule may be stored in the evaluation rule acquisition unit 43 in advance. In this case, the evaluation rule acquisition unit 43 does not have to acquire the evaluation rule from the user terminal 11, and transmits the evaluation rule stored in advance to the first evaluation unit 45.

The first evaluation unit 45 performs one-to-one individual evaluation of each of a plurality of first products and a plurality of second products on the basis of the evaluation rule. That is, the first evaluation unit 45 performs one-to-one individual evaluation of the plurality of first products constituting the evaluation reference group formed by the evaluation reference group information acquisition unit 41, and the second products belonging to a category different from that of the first products on the basis of the evaluation rule. Here, the individual evaluation based on the evaluation rule is performed, for example, on the basis of an evaluation rule table stored in an evaluation rule table database 39. The first evaluation unit 45 transmits a result of the one-to-one individual evaluation to the second evaluation unit 47.

The second evaluation unit 47 performs many-to-one overall evaluation on each of the plurality of second products for the evaluation reference group on the basis of the individual evaluation performed by the first evaluation unit. The overall evaluation performed by the second evaluation unit 47 is performed on the basis of a plurality of individual evaluations that the second products have. For example, the second evaluation unit 47 performs the overall evaluation by summing a plurality of individual evaluation values that the second products have, to calculate a total evaluation value.

In a case where there are a plurality of second products, the second evaluation unit 47 may select the second product to be recommended to the user according to the overall evaluation. For example, the second evaluation unit 47 may recommend a second product of which the total evaluation value is within top 100. The individual evaluation performed by the first evaluation unit 45 and the overall evaluation that is performed by the second evaluation unit 47 will be described in detail below.

The recommendation information output unit 49 outputs recommendation information of the plurality of second products on the basis of the overall evaluation performed by the second evaluation unit. For example, the recommendation information output unit 49 outputs the information on the second products within the top 100 of the comprehensive evaluation value as the recommendation information.

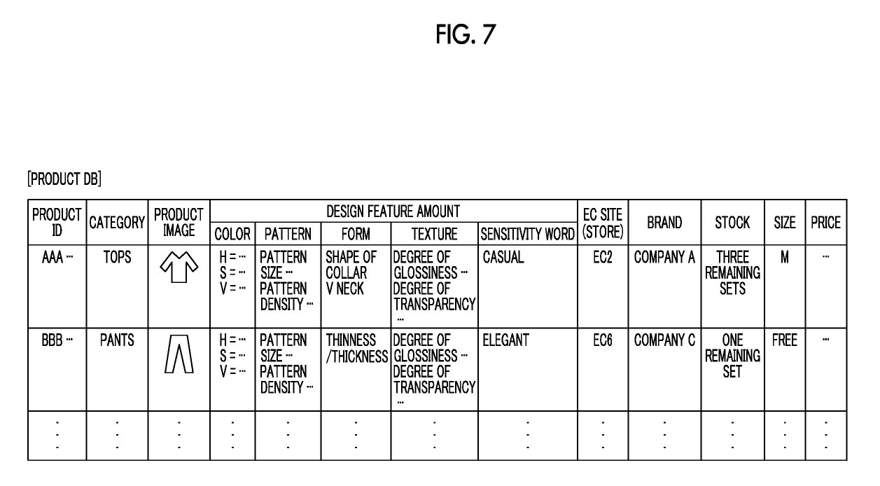

FIG. 7 is a data structure conceptual diagram of data regarding the products stored in the product database 13. Information on a plurality of products including the first products and the second products is stored in the product database 13. Further, the data (information) regarding the products stored in the product database 13 may be acquired from, for example, one or a plurality of EC sites. In a case where the product database 13 acquires data regarding products from a plurality of EC sites, the product database 13 can provide selection of products that traverses the ECs to the user.

As illustrated in FIG. 7, information on “product ID”, “category”, “product image”, “design feature amount”, “EC site”, “brand”, “stock”, “size”, and “price” is registered as the product information in the product database 13. Here, the “product ID” is identification information unique to each product, and when providing sources (suppliers, EC sites, or stores) are different even though the product is same, different product IDs may be assigned. Therefore, a providing source from which a product is provided can be recognized using the product ID.

The “category” is a category of products, and examples of the category include tops, pants (bottoms), hats, and shoes. The category is useful information in a case where the category is combined with other products (coordinated). The “product image” is data of an image obtained by imaging a product.

The “design feature amount” includes, for example, a physical amount of a product image (information on color of the product, information on a pattern of the product, information on a form of the product, and information on a texture of the product) and a sensitivity word associated with the physical amount. The information on the “color” obtained by performing image analysis on the product image is represented by H (hue), S (saturation), and V (brightness), or RGB (red, green, blue).

A design feature amount regarding “pattern” is represented by, for example, by a pattern size or a pattern density. The pattern size is a size of the pattern that the product has, and is represented, for example, by an area. Further, the pattern density indicates how much the pattern is densely arranged in a certain range, and is represented, for example, by “high density”, “low density”, or the like.

Information regarding the “form” is information on a characteristic form of a product or a form from which a product can be identified. The information on the form is, for example, information such as a shape of a collar, slender, or loosing. Information on the “texture” is, for example, a degree of glossiness or a degree of transparency, and is information obtained by performing image analysis on the product image.

Next, information on the sensitivity word associated with the physical amount will be described. First, a relationship between the physical amount and the sensitivity word will be described.

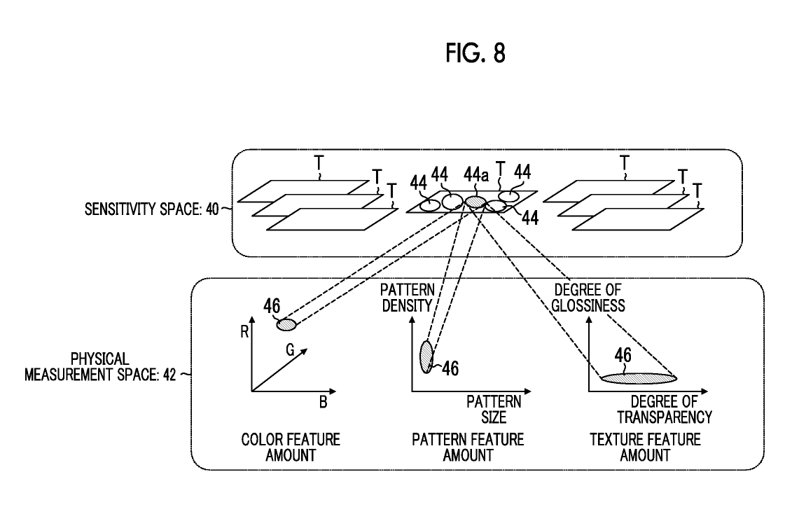

FIG. 8 is a conceptual diagram illustrating a relationship between a sensitivity space 40 and a physical measurement space 42. Conversion from the physical measurement space 42 into the sensitivity space 40 is performed by a conversion table T. That is, the conversion table T defines a region in the physical measurement space 42 (hereinafter referred to as a “physical amount region 46”) corresponding to a region in the sensitivity space 40 (hereinafter referred to as a “sensitivity region 44”). As illustrated in FIG. 8, there are sensitivity regions 44 assigned to respective sensitivity words in the sensitivity space 40 and there is a corresponding physical amount region 46 in the physical measurement space 42 in connection with each sensitivity region 44. In the example illustrated in FIG. 8, in a case where a certain sensitivity word occupies a sensitivity region 44a, a specific physical amount region 46 in the physical measurement space 42 regarding a design feature amount of color, a design feature amount of a pattern, and a design feature amount of a texture is associated with the sensitivity region 44a (see a hatched portion in FIG. 8).

The conversion table T defines association between the sensitivity region 44 represented in the sensitivity space 40 and the physical amount region 46 represented in the physical measurement space 42, and is used to convert data in the sensitivity space 40 into data in the physical measurement space 42.

In the example illustrated in FIG. 8, “color feature amount defined by RGB (red, green, and blue) data”, “pattern feature amount defined by a pattern density and a pattern size”, and “texture feature amount defined by a degree of glossiness and a degree of transparency” are used as references for determining the physical amount region 46 in the physical measurement space 42, but the present invention is not limited thereto.

Information on the sensitivity word associated with the physical amount of the product image is registered in the product database 13, as described above. That is, the sensitivity word obtained using the conversion table T from the physical amount obtained by image analysis from the product image is registered the product database 13 for each product.

Referring back to FIG. 7, “EC site (store)”, “brand”, “stock”, “size”, and “price” for the product are also registered in the product database 13. The product information is not limited to the information illustrated in FIG. 7, and various kinds of other information on the product may be registered in the product database 13 as product information.

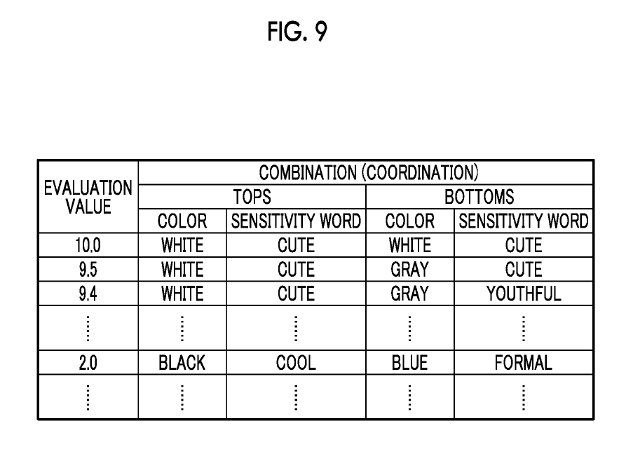

FIG. 9 is a diagram illustrating an example of the evaluation rule table stored in the evaluation rule table database (DB) 39. Evaluation rule table data as illustrated in FIG. 9 is stored in the evaluation rule table database 39, and the first evaluation unit 45 acquires corresponding evaluation rule table data on the basis of the evaluation rule acquired from the evaluation rule acquisition unit 43. In FIG. 9, evaluation rule table data of coordination (combination) regarding “cute” is illustrated as an example of the evaluation rule table data. That is, bottoms of which the color is “white” and the sensitivity word is “cute” relative to tops of which the color is “white” and the sensitivity word is “cute” have an evaluation value of 10.0 in the evaluation rule “cute”. Similarly, bottoms of which the color is “gray” and the sensitivity word is “cute” have an evaluation value of 9.5 in the evaluation rule “cute”, and bottoms of which the color is “gray” and the sensitivity word is “youthful” have an evaluation value of 9.4 in the evaluation rule “cute”. Further, the bottoms of which the color is “blue” and the sensitivity word is “formal” relative to tops of which the color is “black” and the sensitivity word is “cool” have an evaluation value of 2.0 in the evaluation rule “cute”. As described above, the first evaluation unit 45 can acquire, for example, the evaluation rule table data stored in the evaluation rule table database 39 on the basis of the evaluation rule, and perform individual evaluation by referring to the acquired evaluation rule table data.

Content of the evaluation rule table is not limited to the content of FIG. 9, and a variety of combinations of the color, the pattern, the form, the texture, and the sensitivity word of the tops and the bottoms are conceivable. Further, the evaluation rule table may be created, for example, by referring to coordination of famous designers or fashion magazines.

Further, the individual evaluation that is performed by the first evaluation unit 45 is not limited to the evaluation using the evaluation rule table data. For example, the first evaluation unit 45 may perform the individual evaluation on the basis of at least one of a distance in a color space and a distance in the sensitivity space between the first product and the second product.

Next, a specific example of the evaluation that is performed by the first evaluation unit 45 and the second evaluation unit 47 of the present invention will be described. In the specific example that will be described below, the evaluation reference group includes a first product 101, a first product 102, a first product 103, a first product 104, and a first products 105 owned by the user.

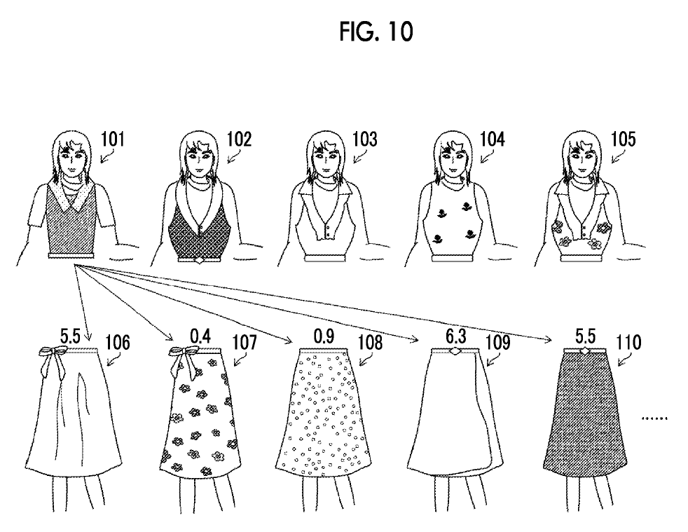

FIGS. 10 to 14 are conceptual diagrams illustrating individual evaluation that is one-to-one evaluation that is performed by the first evaluation unit 45.

In FIGS. 10 to 14, the first evaluation unit 45 performs individual evaluation on the basis of the evaluation rule “cute”. That is, in FIGS. 10 to 14, the first evaluation unit 45 acquires the evaluation rule table data on the basis of the evaluation rule “cute”, and performs individual evaluation of the first product 101 and the second product registered in the product database 13 by referring to the acquired evaluation rule table data.

In the individual evaluation illustrated in FIG. 10, individual evaluation of the first product and the second product is performed, an individual evaluation value of the first product 101 and the second product 106 is 5.5, an individual evaluation value of the first product 101 and the second product 107 is 0.4, an individual evaluation value of the first product 101 and the second product 108 is 0.9, an individual evaluation value of the first product 101 and the second product 109 is 6.3, and an individual evaluation value of the first product 101 and the second product 110 is 5.5.

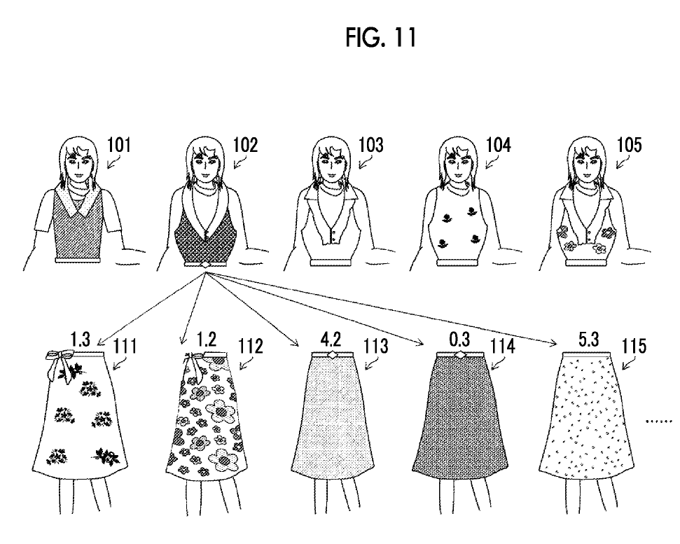

Similarly, in FIG. 11, individual evaluation regarding the first product 102 is illustrated, an individual evaluation value of the first product 102 and the second product 111 is 1.3, an individual evaluation value of the first product 102 and the second product 112 is 1.2, an individual evaluation value of the first product 102 and the second product 113 is 4.2, an individual evaluation value of the first product 102 and the second product 114 is 0.3, and an individual evaluation value of the first product 102 and the second product 115 is 5.3.

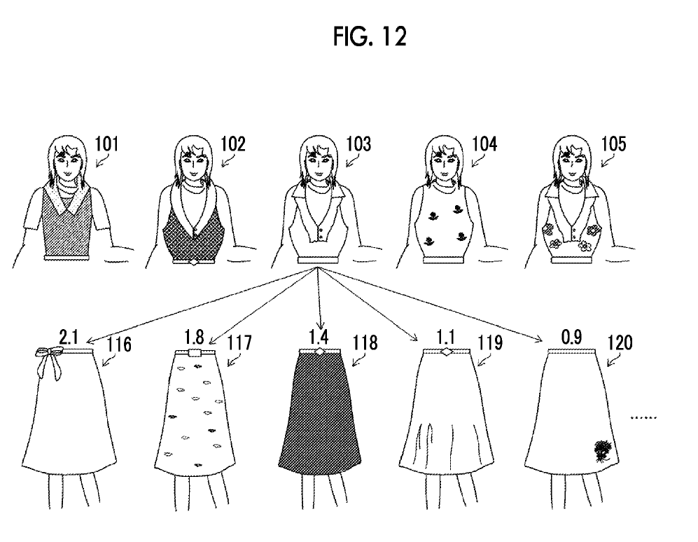

Similarly, in FIG. 12, individual evaluation regarding the first product 103 is illustrated, an individual evaluation value of the first product 103 and the second product 116 is 2.1, an individual evaluation value of the first product 103 and the second product 117 is 1.8, an individual evaluation value of the first product 103 and the second product 118 is 1.4, an individual evaluation value of the first product 103 and the second product 119 is 1.1, and an individual evaluation value of the first product 103 and the second product 120 is 0.9.

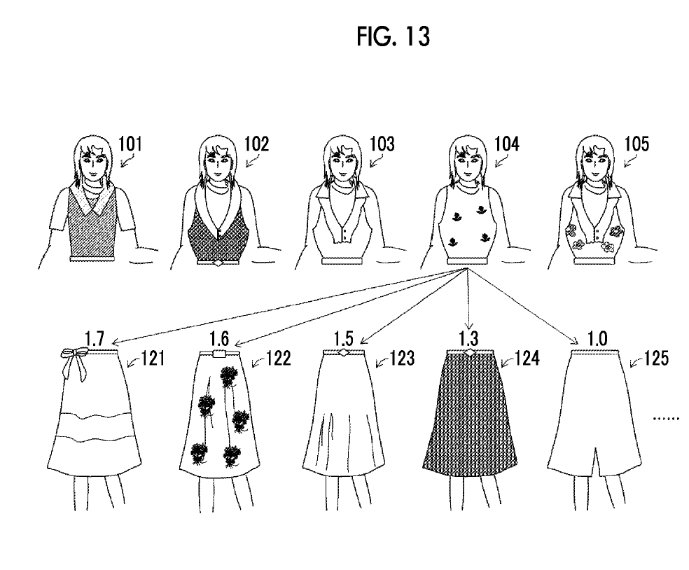

Similarly, in FIG. 13, individual evaluation regarding the first product 104 is illustrated, an individual evaluation value of the first product 104 and the second product 121 is 1.7, an individual evaluation value of the first product 104 and the second product 122 is 1.6, an individual evaluation value of the first product 104 and the second product 123 is 1.5, an individual evaluation value of the first product 104 and the second product 124 is 1.3, and an individual evaluation value of the first product 104 and the second product 125 is 1.0.

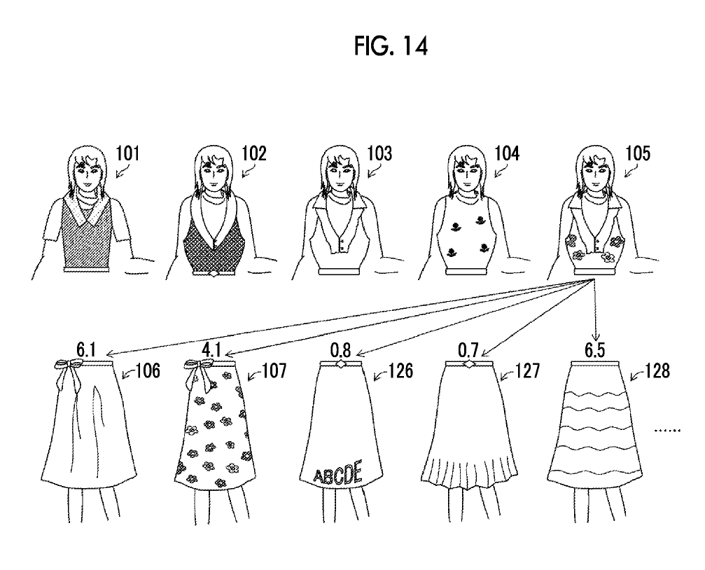

Similarly, in FIG. 14, individual evaluation regarding the first product 105 is illustrated, an individual evaluation value of the first product 105 and the second product 106 is 6.1, an individual evaluation value of the first product 105 and the second product 107 is 4.1, an individual evaluation value of the first product 105 and the second product 126 is 0.8, an individual evaluation value of the first product 105 and the second product 127 is 0.7, and an individual evaluation value of the first product 105 and the second product 128 is 6.5.

As illustrated in FIGS. 10 to 14, the individual evaluation is performed for each of the first products. Then, in the second evaluation unit 47, many-to-one overall evaluation is performed on each of the plurality of second products for the evaluation reference group.

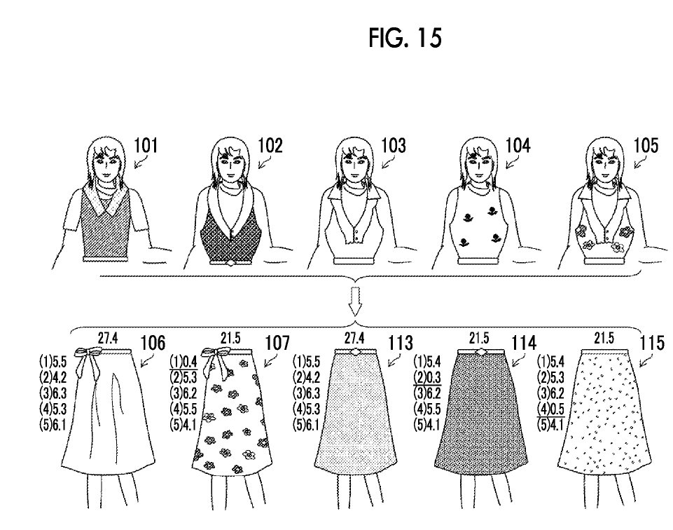

FIG. 15 is a diagram illustrating overall evaluation that is performed by the second evaluation unit 47.

The second product 106 has, as an individual evaluation value, 5.5 (1) relative to the first product 101, 4.2 (2) relative to the first product 102, 6.3 (3) relative to the first product 103, 5.3 (4) relative to the first product 104, and 6.1 (5) relative to the first product 105, and a sum of the individual evaluation values is 27.4, which is a total evaluation value.

Further, the second product 107 in FIG. 15 has, as an individual evaluation value, 0.4 (1) relative to the first product 101, 5.3 (2) relative to the first product 102, 6.2 (3) relative to the first product 103, 5.5 (4) relative to the first product 104, and 4.1 (5) relative to the first product 105, and a sum of the individual evaluation values is 21.5, which is a total evaluation value.

Further, the second product 113 in FIG. 15 has, as an individual evaluation value, 5.5 (1) relative to the first product 101, 4.2 (2) relative to the first product 102, 6.3 (3) relative to the first product 103, 5.3 (4) relative to the first product 104, and 6.1 (5) relative to the first product 105, and a sum of the individual evaluation values is 27.4, which is a total evaluation value.

Further, the second product 114 in FIG. 15 has, as an individual evaluation value, 5.4 (1) relative to the first product 101, 0.3 (2) relative to the first product 102, 6.2 (3) relative to the first product 103, 5.5 (4) relative to the first product 104, and 4.1 (5) relative to the first product 105, and a sum of the individual evaluation values is 21.5, which is a total evaluation value.

Further, the second product 115 in FIG. 15 has, as an individual evaluation value, 5.4 (1) relative to the first product 101, 5.3 (2) relative to the first product 102, 6.2 (3) relative to the first product 103, 0.5 (4) relative to the first product 104, and 4.1 (5) relative to the first product 105, and a sum of the individual evaluation values is 21.5, which is a total evaluation value.

As illustrated in FIG. 15, the second evaluation unit 47 sums the evaluation values that the plurality of respective second products have to calculate a total evaluation value and performs overall evaluation. Further, the second evaluation unit 47 may select the second product on the basis of the calculated total evaluation value. For example, the second evaluation unit 47 can select top five second products having a great total evaluation value (the second product 106, the second product 107, the second product 113, the second product 114, and the second product 115), as illustrated in FIG. 15.

As described above, according to the present invention, one-to-one individual evaluation is performed by the first evaluation unit 45, and many-to-one overall evaluation is performed by the second evaluation unit 47 on the basis of the individual evaluation performed by the first evaluation unit 45. Thus, in this aspect, it is possible to recommend one or a plurality of second products on the basis of the evaluation for a plurality of first products.

<Display Form>

FIG. 16 is a diagram illustrating a display form of recommendation information that is displayed on the display unit 27 of the user terminal 11.

In FIG. 16, product images (indicated by reference signs 201, 202, 203, 204, and 205) of the first products constituting the evaluation reference group are displayed in an upper part of the display unit 27 on the basis of the information on the product images of the first products output from the recommendation information output unit 49. Further, product images (indicated by reference signs 231, 232, 234, 235, and 236) of the second products to be recommended are displayed in a lower part of the display unit 27 on the basis of the information on the product images of the second products output from the recommendation information output unit 49. Further, a mismatch display (indicated by reference signs 210, 211, 212, 213, 214, and 215) is shown on the basis of the display information on the mismatch information output from the recommendation information output unit 49.

The recommendation information output unit 49 has a threshold value for determining the individual evaluation value, and causes mismatch information which is information on the second product having the individual evaluation value equal to or smaller than the threshold value to be included in the recommendation information.

The individual evaluation value of the first product 201 and the second product 232 is 0.4, the individual evaluation value of the first product 202 and the second product 235 is 0.3, the individual evaluation value of the first product 204 and the second product 236 is 0.5, and these individual evaluation values are equal to or smaller than the threshold value for determining the individual evaluation value. Accordingly, the recommendation information output unit 49 causes the mismatch information to be included in the recommendation information.

Although various aspects can be adopted for a mismatch display based on the mismatch information, a display (see arrow 210, arrow 211, and arrow 212 in FIG. 16) may be performed, for example, so that a user can recognize a combination of the first products of which the individual evaluation value is smaller than the threshold value and the second products as illustrated in FIG. 16, and a display (see mark×213, mark×214, and mark×215 in FIG. 16) may be performed so that a user can recognize that the combination is not suitable. Thus, the user can visually recognize whether or not the combination of the first product and the second product is appropriate. The threshold value for determining an individual evaluation value is appropriately determined according to settings of the user or content of the recommendation.

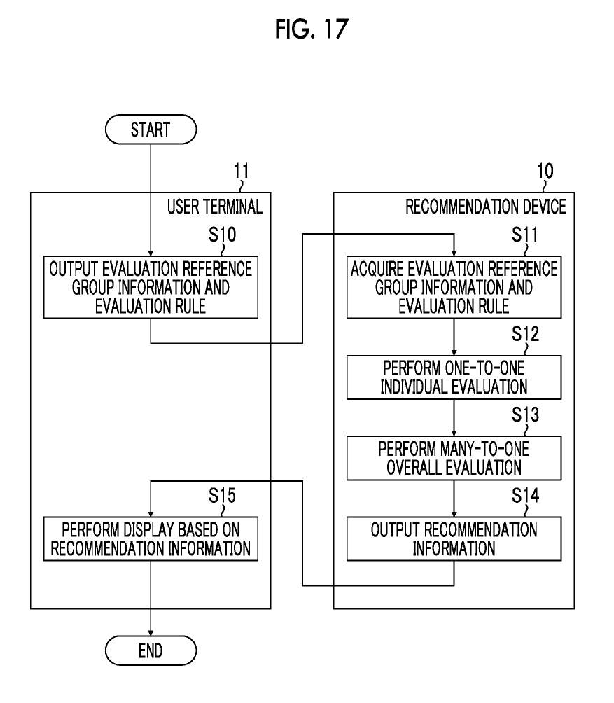

FIG. 17 is a diagram illustrating an operation flow of the recommendation system 1.

First, on the basis of an instruction input to the input unit 20 of the user of the user terminal 11, the evaluation reference group information is output from the evaluation reference group information output unit 24, and the evaluation rule is output from the evaluation rule output unit 26 (step S10). The evaluation reference group information output from the evaluation reference group information output unit 24 and the evaluation rule output from the evaluation rule output unit 26 are transmitted to the recommendation device 10 via the transmission unit 21.

The recommendation device 10 receives the evaluation reference group information and the evaluation rule transmitted from the user terminal 11 using the reception unit 32. Then, the evaluation reference group information is acquired by the evaluation reference group information acquisition unit 41, and the evaluation rule is acquired by the evaluation rule acquisition unit 43 (step S11). Then, one-to-one individual evaluation of each of the plurality of first products specified on the basis of the evaluation reference group information and the second product stored in the product database 13 is performed on the basis of the evaluation rule by the first evaluation unit 45 (step S12). Then, many-to-one overall evaluation is performed on each of the plurality of second products on the basis of the one-to-one individual evaluation performed by the first evaluation unit 45, by the second evaluation unit 47 (step S13). The recommendation information is output on the basis of the many-to-one overall evaluation performed by the second evaluation unit 47, by the recommendation information output unit 49 (step S14). The recommendation information output by the recommendation information output unit 49 is transmitted to the user terminal 11 via the transmission unit 31.

Then, the user terminal 11 receives the transmitted recommendation information using the reception unit 22. Thereafter, a display based on the recommendation information is performed on the display unit 27 by the display control unit 25 (step S15).

Each configuration and each function described above can be appropriately realized by arbitrary hardware, arbitrary software, or a combination of both. For example, the present invention is applicable to a program for causing a computer to execute the above-described process steps (process procedures), a computer-readable recording medium (non-transitory recording medium) having such a program recorded thereon, or a computer in which such a program can be installed.

The example of the present invention has been described above, but the present invention is not limited to the above-described embodiment, and it is to be understood that various modifications can be made without departing from the scope and spirit of the present invention.

### EXPLANATION OF REFERENCES

1: recommendation system

10: recommendation device

11: user terminal

12: network

13: product database

20: input unit

21: transmission unit

22: reception unit

23: communication unit

24: evaluation reference group information output unit

25: display control unit

26: evaluation rule output unit

27: display unit

28: system controller

31: transmission unit

32: reception unit

33: communication unit

39: evaluation rule table database

40: sensitivity space

41: evaluation reference group information acquisition unit

42: physical measurement space

43: evaluation rule acquisition unit

44: sensitivity region

44a: sensitivity region

45: first evaluation unit

46: physical amount region

47: second evaluation unit

49: recommendation information output unit

62: software keyboard

What is claimed is:

1. A recommendation device that evaluates each of a plurality of first products constituting an evaluation reference group and a plurality of second products belonging to a category different from that of the first products on the basis of an evaluation rule, and performs recommendation of one or a plurality of second products, the recommendation device comprising:
an evaluation reference group information acquisition unit that acquires evaluation reference group information related to the plurality of first products constituting the evaluation reference group;
an evaluation rule acquisition unit that acquires the evaluation rule;
a first evaluation unit that performs individual evaluation of one-to-one of each of the plurality of first products and the plurality of second products on the basis of the evaluation rule;
a second evaluation unit that performs many-to-one overall evaluation on each of the plurality of second products for the evaluation reference group on the basis of the individual evaluation performed by the first evaluation unit; and
a recommendation information output unit that outputs recommendation information of the plurality of second products on the basis of the overall evaluation performed by the second evaluation unit.

2. The recommendation device according to claim 1,
wherein the first evaluation unit calculates an individual evaluation value for each individual evaluation, and
the second evaluation unit performs the overall evaluation on each of the plurality of second products using the individual evaluation value.

3. The recommendation device according to claim 2,
wherein the overall evaluation is performed by calculating a total evaluation value obtained by summing the individual evaluation values.

4. The recommendation device according to claim 2,
wherein the recommendation information output unit has a threshold value for determining the individual evaluation value, and causes mismatch information which is information on the second product having the individual evaluation value equal to or smaller than the threshold value to be included in the recommendation information.

5. The recommendation device according to claim 3,
wherein the recommendation information output unit has a threshold value for determining the individual evaluation value, and causes mismatch information which is information on the second product having the individual evaluation value equal to or smaller than the threshold value to be included in the recommendation information.

6. The recommendation device according to claim 4,
wherein the mismatch information includes information on the first product of which the individual evaluation value is equal to or smaller than the threshold value, and the second product.

7. The recommendation device according to claim 5,
wherein the mismatch information includes information on the first product of which the individual evaluation value is equal to or smaller than the threshold value, and the second product.

8. The recommendation device according to claim 4,
wherein the recommendation information includes information on a product image of the first product, information on a product image of the second product, and display information on the mismatch information.

9. The recommendation device according to claim 5,
wherein the recommendation information includes information on a product image of the first product, information on a product image of the second product, and display information on the mismatch information.

10. The recommendation device according to claim 1,
wherein the first evaluation unit sets products stored in a product database as the second products and performs the individual evaluation.

11. The recommendation device according to claim 2,
wherein the first evaluation unit sets products stored in a product database as the second products and performs the individual evaluation.

12. The recommendation device according to claim 1,
wherein the evaluation reference group information acquisition unit acquires purchase history information of a user and favorite information of the user as the evaluation reference group information.

13. The recommendation device according to claim 2,
wherein the evaluation reference group information acquisition unit acquires purchase history information of a user and favorite information of the user as the evaluation reference group information.

14. The recommendation device according to claim 1,
wherein the first product and the second product are clothing-related products.

15. The recommendation device according to claim 2,
wherein the first product and the second product are clothing-related products.

16. A recommendation system comprising:
a user terminal; and
a recommendation device connected to the user terminal over a network, the recommendation device evaluating each of a plurality of first products constituting an evaluation reference group and a plurality of second products belonging to a category different from that of the first products on the basis of an evaluation rule, and performing recommendation of one or a plurality of second products,
wherein the recommendation device includes
an evaluation reference group information acquisition unit that acquires evaluation reference group information related to the plurality of first products constituting the evaluation reference group,
an evaluation rule acquisition unit that acquires the evaluation rule,
a first evaluation unit that performs individual evaluation of one-to-one of each of the plurality of first products and the plurality of second products on the basis of the evaluation rule,
a second evaluation unit that performs many-to-one overall evaluation on each of the plurality of second products for the evaluation reference group on the basis of the individual evaluation performed by the first evaluation unit, and
a recommendation information output unit that outputs recommendation information of the plurality of second products on the basis of the overall evaluation performed by the second evaluation unit, and
the user terminal includes
a display unit, and
a display control unit that causes the display unit to perform a display based on the recommendation information, on the basis of the recommendation information acquired from the recommendation device.

17. The recommendation system according to claim 16,
wherein the evaluation reference group information acquisition unit of the recommendation device acquires the evaluation reference group information from the user terminal, and
the user terminal includes an evaluation reference group information output unit that outputs the evaluation reference group information to the recommendation device.

18. The recommendation system according to claim 16,
wherein the evaluation rule acquisition unit of the recommendation device acquires the evaluation rule from the user terminal, and
the user terminal includes an evaluation rule output unit that outputs the evaluation rule to the recommendation device.

19. A recommendation method of evaluating each of a plurality of first products constituting an evaluation reference group and a plurality of second products belonging to a category different from that of the first products on the basis of an evaluation rule, and performing recommendation of one or a plurality of second products, the recommendation method comprising:
an evaluation reference group information acquisition step of acquiring evaluation reference group information related to the plurality of first products constituting the evaluation reference group;
an evaluation rule acquisition step of acquiring the evaluation rule;
a first evaluation step of performing individual evaluation of one-to-one of each of the plurality of first products and the plurality of second products on the basis of the evaluation rule;
a second evaluation step of performing many-to-one overall evaluation on each of the plurality of second products for the evaluation reference group on the basis of the individual evaluation performed in the first evaluation step; and
a recommendation information output step of outputting recommendation information of the plurality of second products on the basis of the overall evaluation performed in the second evaluation step.

20. Non-transitory computer recording medium storing a program that causes a computer to execute a process of evaluating each of a plurality of first products constituting an evaluation reference group and a plurality of second products belonging to a category different from that of the first products on the basis of an evaluation rule, and performing recommendation of one or a plurality of second products, the program causing the computer to execute a process including:
an evaluation reference group information acquisition step of acquiring evaluation reference group information related to the plurality of first products constituting the evaluation reference group;
an evaluation rule acquisition step of acquiring the evaluation rule;
a first evaluation step of performing individual evaluation of one-to-one of each of the plurality of first products and the plurality of second products on the basis of the evaluation rule;
a second evaluation step of performing many-to-one overall evaluation on each of the plurality of second products for the evaluation reference group on the basis of the individual evaluation performed in the first evaluation step; and
a recommendation information output step of outputting recommendation information of the plurality of second products on the basis of the overall evaluation performed in the second evaluation step.
